(19) United States
(12) Patent Application Publication
(10) Pub. No.: US 2005/0058522 A1
(43) Pub. Date: Mar. 17, 2005

(54) Permanently fixable plug

(75) Inventors: Mark Christopher Hughes, Stourbridge (GB); Janusz Lucien Holland, Edgbaston (GB)

Correspondence Address: NIKOLAI & MERSEREAU, P.A., 900 SECOND AVENUE SOUTH, SUITE 820, MINNEAPOLIS, MN, 55402, US

(73) Assignee: Realty Products Limited, Birmingham (GB)

(21) Appl. No.: 10/871,688

(22) Filed: Jun. 11, 2004

Related U.S. Application Data
(63) Continuation of application No. PCT/GB02/05647, filed on Dec. 13, 2002.

(30) Foreign Application Priority Data
Dec. 13, 2001 (GB) 0129823.1

(51) Int. Cl. F16B 39/02

(52) U.S. Cl. 411/82

(57) ABSTRACT

A fixing plug adapted for permanent anchoring within a bore in a wall, said plug comprising a first elongate hollow member (1) having an internal bore (2) containing a flowable adhesive medium, the first hollow member being provided with outwardly projecting fin means (6) for engagement with the bore sidewall so as to define, in use, a gap between the first elongate hollow member (1) and the bore sidewall, at least one fluid port adapted to provide fluid communication betwenn said internal bore of the first elongate hollow member (1) and said gap, a second elongate hollow plunger member (10) adapted to be inserted into said internal bore (2) of the first hollow member (1) to a fully inserted position in order to cause said adhesive medium to flow through said at least one fluid port and into said gap, said second member (10) having an internal bore (15) adapted to receive a screw (14) and having at least one fluid port (11) adapted to provide fluid communication between the internal bore (15) of the second elongate member (10) and the internal bore (2) of the first elongate member (1), said adhesive medium being caused to flow through said at least one fluid port (11) of the second elongate member (10) and contact said screw (14) on insertion of said screw into said internal bore (15) of the second elongate member (10).

The present invention relates to a permanently fixable plug. More particularly, but not exclusively, it relates to a method of anchoring permanently in a wall or other substrate (hereinafter referred to as a wall) a fixing plug and also to a fixing plug which enables such a method to be carried out efficiently.

It is well known to provide anchorages to a wall by drilling a hole in the wall and, inserting therein an expandable fixing plug and inserting a screw into that fixing plug to expand it into firm contact with the walls of the hole. Such anchorages are reasonably secure but not perfectly so. The bond between the wall and the plug may fail and, of course, it will always be possible to unscrew the screw.

In many circumstances, especially where the item to be anchored is valuable or treasured, where accidental removal would be calamitous, or where security is important (for example when fixing door locks, hinges, padlock hasps or even door or window frames) it would be advantageous if the plug could be fixed permanently within the hole and if the screw could be fixed irremovably within the plug, itself fixed within the hole.

It is known from German Patent Application No. DE A1 19813089 to provide an adhesive bond between the plug and the wall of the hole, by means of an adhesive package which is pierced, punctured or fractured by an impermeable piston. Hence, the adhesive will bond the plug to the wall, but it does not extend to bonding between the plug and the screw. Therefore the adhesive does not assist in preventing the screw from being pulled out under high loads.

It is an object of the present invention to provide a permanently fixable plug in which an adhesive may be spread, not only between the plug and the wall, but also between the plug and its co-operating screw.

According to a first aspect of the present invention there is provided a fixing plug adapted for permanent anchoring within a bore in a wall, said plug comprising a first elongate hollow member having an internal bore containing a flowable adhesive medium, the first hollow member being provided with outwardly projecting fin means for engagement with the bore sidewall so as to define, in use, a gap between the first elongate hollow member and the bore sidewall, at least one fluid port adapted to provide fluid communication between said internal bore of the first elongate hollow member and said gap, a second elongate hollow plunger member adapted to be inserted into said internal bore of the first hollow member to a fully inserted position in order to cause said adhesive medium to flow through said at least one fluid port and into said gap, said second member having an internal bore adapted to receive a screw and having at least one fluid port adapted to provide fluid communication between the internal bore of the second elongate member and the internal bore of the first elongate member, said adhesive medium being caused to flow through said at least one fluid port of the second elongate member and contact said screw on insertion of said screw into said internal bore of the second elongate member.

Preferably said first member is formed as an open ended closed container which is pre-filled with said adhesive medium and its opening sealed with penetrable membrane such as a frangible seal. Preferably in such an arrangement the at least one fluid port is defined by a frangible wall portion of the first elongate member.

Advantageously, the second member is provided with at least one frangible zone to define a fluid port, which may be ruptured by the insertion of the screw into the second member expanding the second member radially.

Alternatively and/or additionally, the first member may be provided with at least one radially inwardly extending fin means, adapted to cooperate with a respective at least one frangible zone of the second member, to bear rupturingly thereon when a screw is inserted into the second member.

Preferably, the first member comprises at least three said outwardly extending fin means, and advantageously four.

The first member may then comprise at least three said frangible zones, and advantageously four.

The second member may be configured to fit closely within the first member.

The first member is preferably closed at one end and at an end remote therefrom it may be closed by a frangible seal, penetrable by a distal end of the second member.

The second member may be provided with a generally pointed distal end adapted to penetrate said seal.

The seal may comprise a foil of metal or plastics material.

The first member and the second member may each comprise a plastics material, advantageously an injection-mouldable thermoplastics material, such as polyethylene, polypropylene, nylon or an acrylic copolymer.

The adhesive medium is preferably a single component adhesive composition.

The adhesive medium may be a water-based latex or emulsion adhesive composition, optionally one comprising polyvinyl acetate or polyacrylate homopolymers or copolymers.

According to a second aspect of the present invention there is provided a method of permanently anchoring to a wall comprising the steps providing a fixing plug as described above, inserting a first member thereof into a hole in the wall, inserting a second member thereof into the first member to expel adhesive therefrom and inserting a screw or other similar fixing into said second member to cause adhesive to flow from the exterior of said first member into the interior of said second member.

The method may comprise the additional step of filling said first member with adhesive medium, carried out either before or after the first member is inserted into a hole in the wall.

An embodiment of the present invention will now be more particularly described by way of example and with reference to the accompanying drawings, in which:

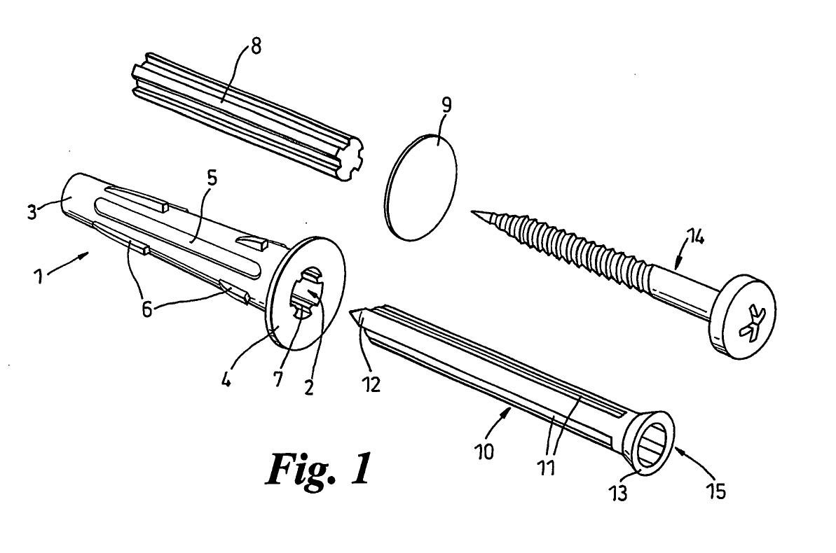

FIG. 1 shows a fixing plug embodying the invention with its components in separated condition;

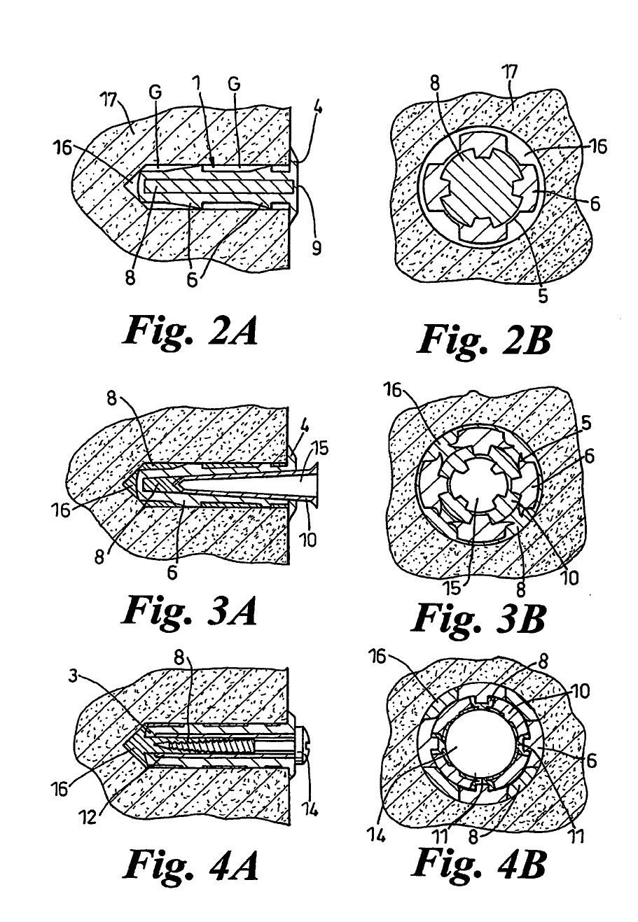

FIGS. 2A and 2B show in longitudinal and cross section a first member of the fixing plug in situ in a wall;

FIGS. 3A and 3B show in longitudinal and cross section a first member of the fixing plug in situ in a wall with a second member partially inserted; and

FIGS. 4A and 4B show in longitudinal and cross section the fixing plug of the invention with first and second members and a fixing screw held permanently in place.

Referring now to the drawings, and to FIG. 1 in particular, a fixing plug comprises a generally cylindrical cartridge (or first member) 1 with a coaxial bore 2. The cartridge 1 is closed at a distal end 3, is open at its proximal end and is provided with an annular radially directed flange 4 at the proximal end. The cartridge 1 is continually walled to define a closed fluid tight container and is provided with four longitudinally extending frangible zones 5 disposed equiangularly around its wall and four sets of outwardly extending longitudinally extending fins 6, each set of fins 6 being disposed between a pair of frangible zones 5. The bore 2 is provided with four inwardly extending longitudinal ribs 7, each rib 7 being disposed opposite to a respective set of fins 6.

The bore 2 of the cartridge 1 contains a charge 8 of adhesive; this may be a liquid composition or a gelled composition which is flowable under pressure. The preferred adhesive composition is a water-based latex adhesive comprising polyvinyl acetate, polyacrylate or a copolymer thereof, although other adhesives may be appropriate. The adhesive charge 8, substantially fills the interior of the bore 2, as shown, and the bore 2 is closed with a foil seal 9 mounted sealingly across the flange 4.

The fixing plug further comprises a generally cylindrical hollow plunger (or second member) 10, dimensioned to be insertable within the bore 2 of the cartridge 1 so as to expand the cartridge 1 and rupture the frangible zones 5 thereof. On rupture of the zones 5, fluid ports are defined which permit adhesive to flow therethrough.

The plunger 10 is provided with four longitudinally extending frangible zones 11, which correspond with the ribs 7 within the bore 2. The plunger 10 has a pointed closed distal tip 12, adapted to penetrate the foil 9, and an open proximal end 13, adapted to receive a suitable screw 14. The bore 15 of the plunger 10 is of such a diameter that insertion of the screw 14 thereinto will urge the plunger 10 to expand radially.

The use of the fixing plug is shown in FIGS. 2A to 4B. As shown in FIGS. 2A and 2B, a cylindrical bore 16 of suitable diameter has been drilled into a substrate 17 (for example, a wall). A cartridge 1, complete with an adhesive charge 8, is inserted into the hole 16. The sets of longitudinal fins 6 contact the walls of the bore 16 and hold the cartridge 1 in alignment whilst creating a gap G between the member 1 and the wall of the bore 16. The flange 4 contacts a surface of the substrate 17 around the bore 16, closing off an interior of the bore 16. The foil 9 is in place over the flange 4, retaining the adhesive charge 8.

In FIGS. 3A and 3B, the plunger 10 has been inserted through the foil 9 into the bore 2 of the cartridge 1. The pressure exerted on the adhesive charge 8 by the plunger 10 has caused the frangible zones 5 of the cartridge to burst, forming fluid ports through which a majority of the adhesive charge 8 is discharged from the cartridge 1 into the gap G between the cartridge 1 and bore wall 16. The volumes of the fins 6, the bore 16 and the adhesive charge 8 are preselected so that the interior of the bore 16 may be substantially filled with adhesive displaced by the plunger 10, while little or no adhesive is forced out of the bore 16 past the flange 4 of the cartridge 1.

In FIGS. 4A and 4B, the plunger 10 has been forced completely into the bore 2 of the cartridge 1. A screw 14 has then been inserted into the bore 15 of the plunger 10, forcing its wall outwardly and causing rupture of the frangible zones 11 of the plunger 10 to form fluid ports for adhesive to flow through. The outward expansion of the walls of the plunger 10 also urges the walls and fins 6 of the cartridge 1 further outwardly, forcing the adhesive outward of the cartridge 1 to flow inwardly through both the ruptured frangible zones 5 of the cartridge 1 and the ruptured frangible zones 11 of the plunger 10, into the bore 15 of the plunger. Preferably the distal end 3 of the cartridge and the distal tip 12 of the plunger 10 are also forced open by the screw 14.

The adhesive 8 is thus present between the cartridge 1 and the wall of the bore 16, between the cartridge 1 and the plunger 10, and between the plunger 10 and the screw 14. When set, the adhesive will therefore bond each component of the fixing plug and the screw to each other and to the walls of the hole. Removal of the screw or of the plug from the substrate by exertion of a pulling force will be extremely difficult or impossible. Whilst the adhesive is curing, the interaction between the screw, plug and bore 16 firmly hold the screw within the bore 16.

The fixing plug disclosed permits the effectively permanent and secure fixing of items to a substrate with a conventional screw. The entire ensemble of screw and plug is bonded together and to the substrate. The method disclosed is rapid, convenient and simple, and there is no spillage of adhesive, such as would occur if a conventional fixing plug were filled with adhesive, inserted into a bore also treated with adhesive, and a screw were then introduced into the plug.

It is envisaged that the adhesive charge 8 may itself be contained within a frangible fully enclosed sealed container which is broken open by insertion of the second member 10 to release the adhesive. With such an arrangement, the fluid ports in te first and/or second members may be defined by open apertures.

1. A fixing plug adapted for permanent anchoring within a bore in a wall, said plug comprising a first elongate hollow member having an internal bore containing a flowable adhesive medium, the first hollow member being provided with outwardly projecting fin means for engagement with the bore sidewall so as to define, in use, a gap between the first elongate hollow member and the bore sidewall, at least one fluid port adapted to provide fluid communication between said internal bore of the first elongate hollow member and said gap, a second elongate hollow plunger member adapted to be inserted into said internal bore of the first hollow member to a fully inserted position in order to cause said adhesive medium to flow through said at least one fluid port and into said gap, said second member having an internal bore adapted to receive a screw and having at least one fluid port adapted to provide fluid communication between the internal bore of the second elongate member and the internal bore of the first elongate member, said adhesive medium being caused to flow through said at least one fluid port of the second elongate member and contact said screw on insertion of said screw into said internal bore of the second elongate member.

2. A fixing plug according to claim 1 wherein said first elongate member defines a closed container open at one end and in which said adhesive medium is contained, said at least one fluid port of the first elongate member being defined by a frangible wall portion which is caused to be broken to open said fluid port on insertion of the second elongate member into said first elongate member.

3. A fixing plug according to claim 2 wherein at the proximate end of the first elongate member there is provided a radially projecting flange which serves to limit insertion of the first elongate member axially along said wall.

4. A fixing plug according to claim 2 or 3 wherein said open end of the first elongate member is sealingly closed by a membrane.

5. A fixing plug according to claim 4 wherein the membrane is a metal foil.

6. A fixing plug according to claim 5 wherein the terminal end of the second elongate member is adapted to puncture said membrane on insertion of the second elongate member into the first elongate member.

7. A fixing plug according to claim 1 wherein said second elongate member has a frangible wall portion which defines said at least one fluid port, said frangible wall portion being caused to be broken to open said fluid port on insertion of the screw into the second elongate member.

8. A method of permanently anchoring to a wall comprising the steps providing a fixing plug according to claim 1, inserting a first member thereof into a hole in the wall, inserting a second member thereof into the first member to expel adhesive therefrom and inserting a screw or other similar fixing into said second member to cause adhesive to flow from the exterior of said first member into the interior of said second member.
